(19) United States
(12) Patent Application Publication
(10) Pub. No.: US 2015/0178587 A1
(43) Pub. Date: Jun. 25, 2015

(54) DEVICE AND A METHOD FOR COLOR HARMONIZATION OF AN IMAGE

(71) Applicant: THOMSON LICENSING, Issy de Moulineaux (FR)

(72) Inventors: Christel Chamaret, Chantepie (FR); Yoann Baveye, Saint_Ave (FR); Fabrice Urban, Cesson Sevigne (FR)

(21) Appl. No.: 14/409,447

(22) PCT Filed: Jun. 13, 2013
(86) PCT No.: PCT/EP2013/062304

§ 371 Date: Dec. 18, 2014

(30) Foreign Application Priority Data
Jun. 18, 2012 (EP) 12305693.9

(51) Int. Cl. G06K 9/46; G06T 5/40; H04N 1/60; G06T 5/00

(52) U.S. Cl. CPC G06K 9/4642; G06T 5/005; G06T 5/40; G06K 9/4652; G06K 9/4609; H04N 1/6075; G06T 2207/10024; G06T 2207/20172

(57) ABSTRACT

A method for processing an image is disclosed. The method comprises:
determining regions of interest in the image;
determining a color histogram of the regions of interest;
selecting a first template that matches the color histogram in a set of templates, each template defining a portion of harmonious color values; and
processing the image, wherein processing the image comprises mapping the colors of the image into a final template, the final template being the first template.

### 1. FIELD OF THE INVENTION

The invention relates to a method and a device for processing an image. More precisely, the method of image processing comprises mapping the colors of the image into a template of harmonious colors.

### 2. BACKGROUND OF THE INVENTION

It is known to correct colors in images or in some parts of the images to improve the perceptual experience. As an example, images with saturated colors are advantageously processed to remove these saturated colors and thus improve the perceptual experience.

Document entitled “Color Harmonization” from Cohen-Or teaches a method for harmonizing images based on the same harmonious templates. These templates are depicted on FIG. 1. This method has several drawbacks. First, algorithms are not fully automatic, but require manual annotation for “sensitive” areas (typically skin or sky that look unnatural if they lose their original color). Second, color mapping is very basic. It maps color palette of the original image by applying a Gaussian filter constraint in a template.

### 3. BRIEF SUMMARY OF THE INVENTION

The invention is aimed at alleviating at least one of the drawbacks of the prior art. To this aim, the invention relates to a method for processing an image comprising:
determining regions of interest in the image;
determining a color histogram of the regions of interest;
selecting a first template that matches the color histogram in a set of templates, each template defining a portion of harmonious color values; and
processing the image, wherein processing the image comprises mapping the colors of the image into a final template, the final template being the first template.

The method according to the invention improves image perceptual quality over prior art solutions. In addition, the method is fully automatic.

According to another aspect of the invention, the method further comprises determining a color histogram of the image, selecting a second template that matches the color histogram of the image, combining the first and the second templates into a combined template and selecting a template in the set of templates that matches the combined template, wherein the final template is the template selected that matches the combined template.

Advantageously, a template being made of different portions, the method further comprises segmenting the image into regions of similar colors and wherein, in processing the image, pixels in the same segmented regions are mapped into one and the same portion of the final template.

According to a specific embodiment, selecting a template that matches a color histogram comprises computing Kullback-Leibler divergence between a distribution of probability of the template and the color histogram.

According to a specific characteristic of the invention, the color histograms are computed in the HSV color space as follows:

$${M}_{i} = \frac{1}{{\sum }_{( x , y )} S [ x , y ] * V [ x , y ]} * {\sum }_{( x , y ) ∈ \{ ( u , v ) \backslash H [ u , v ] = i \}} S [ x , y ] * V [ x , y ]$$

where Mi is the i^{st} bin of the corresponding color histogram;

H[u,v] is the Hue value of pixel [u,v];

S [x,y] is the Saturation value of pixel [x,y]; and

V [x,y] is the Value value of pixel [x,y].

Advantageously, the regions of interests are determined by binarising a saliency maps.

Advantageously, mapping the colors of the image into a final template is done according to a sigmoid function.

According to another aspect, the method further comprises blurring the pixels located on a border.

The invention further relates to a device for processing an image comprising:
means for determining regions of interest in the image;
means for determining a color histogram of the regions of interest;
means for selecting a first template that matches the color histogram in a set of templates, each template defining a portion of harmonious color values; and
means for processing the image, wherein processing the image comprises mapping the colors of the image into a final template, the final template being the first template.

Advantageously, the device is adapted to execute the steps of the method for processing.

### 4. BRIEF DESCRIPTION OF THE DRAWINGS

Other features and advantages of the invention will appear with the following description of some of its embodiments, this description being made in connection with the drawings in which:

FIG. 1 represents color templates;

FIG. 2 depicts a flowchart of the image processing method according to the invention;

FIG. 3 represents a hue wheel and mapping directions of two pixels A and B; and

FIG. 4 depicts an image processing device according to the invention.

### 5. DETAILED DESCRIPTION OF THE INVENTION

This invention aims at improving the visual experience by rendering colors in a more harmonious way. Indeed, when an image has one object of non-interest with a “strange” color (different from the global hue of the image), there is a need to correct that color.

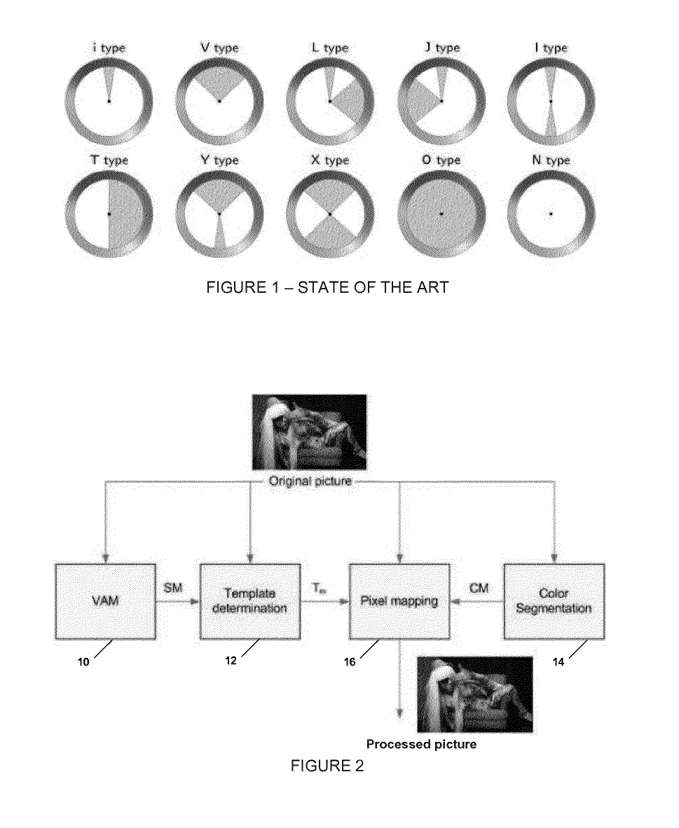

First, regions of interest in the image are determined. Then, the color histograms of these regions of interest are computed. The method then finds the closest harmonious template by perceptually choosing the most attractive pixels. A template is a set of HSV values (hue, saturation and value) that are considered as rendering/reflecting a global harmonious effect when present at the same time. Each template is made of different portions/sectors as depicted on FIG. 1. Once the closest harmonious template is estimated for example via the minimization of an energy, the color considered as being non-harmonious (i.e. whose color values are outside the template's sectors) are mapped into the template (or very close to this last one) by means of a tone mapping function.

A complete implementation of the invention is depicted in FIG. 2. Some of the steps of the method are optional. The four involved steps of the method are described below. One can notice that the following method can be extended to video source by applying same process to consecutive frames.

At a step 10, regions of interest are determined. The invention is not limited by the way the regions of interest are determined. According to a specific embodiment, a saliency map is built that represents the most visually attractive pixels with values from 0 to 255. By binarising the saliency map one is able to determine the regions of interest, i.e. the regions whose saliency value is higher than a threshold value. Building the saliency map is based on the modeling of visual system. Such a visual attention model was patented in EP patent application 04804828.4 published on Jun. 30, 2005 under number 1695288.

At a step 12, one of the templates Tₘ (m∈ {i, I, L, T, V, X, Y, J, O}) depicted on FIG. 1 and defined in “Color Harmonization” from Cohen-Or is selected subject to a rotation by α. Therefore, not only a template T is selected but a template with an orientation. The template of type N is not used. For the sake of clarity, a template is also used to mean a template type with an orientation. The color histogram M of the regions of interest or salient parts of the images is computed in HSV space such as defined below in order to help choosing one template. It is the normalized hue distribution weighted by saturation and value:

$${M}_{i} = \frac{1}{{\sum }_{( x , y )} S [ x , y ] * V [ x , y ]} * {\sum }_{( x , y ) ∈ \{ ( u , v ) \backslash H [ u , v ] = i \}} S [ x , y ] * V [ x , y ]$$

i usually but not necessarily varies from 0 to 360.

Then, the appropriate template Tₘ₀ and the associated orientation α0 that best fits the hue distribution M is chosen by minimizing the Kullback-Leibler divergence computed for each template and each orientation:

$${min}_{m , α} {\sum }_{i} {M}_{i} * ln ( \frac{{M}_{i}}{{P}_{i} ( m , α )} )$$

where P(m, α) is the distribution of template m for the orientation α. Here P(m, α) typically represents a harmonized model, description, or approximation of M. Pᵢ indicates one bin of the distribution and Mᵢ one bin of the histogram. According to a variant, the template Tₘ₀ and the associated orientation α0 are selected such that it matches the hue distribution M, i.e. such that the Kullback-Leibler divergence

$$d 0 = {\sum }_{i} {M}_{i} * ln ( \frac{{M}_{i}}{{P}_{i} ( m 0 , α 0 )} )$$

is below a threshold value. In this case, the template is not necessarily the one that best fits the hue distribution M, but it is close to the hue distribution M.

According to another embodiment, step 12 is executed another time on the whole image in order to find the template that best fits the image. The color histogram M′ of the original image is computed in HSV space such as defined below in order to help choosing one template. It is the normalized hue distribution weighted by saturation and value:

$${M}_{i}^{′} = \frac{1}{{\sum }_{( x , y )} S [ x , y ] * V [ x , y ]} * {\sum }_{( x , y ) ∈ \{ ( u , v ) \backslash H [ u , v ] = i \}} S [ x , y ] * V [ x , y ]$$

Then, the appropriate template Tₘ₁ and the associated orientation α1 that best fits the hue distribution M′ is chosen by minimizing the Kullback-Leibler divergence computed for each template and each orientation:

$${min}_{m , α} {\sum }_{i} {M}_{i}^{′} * ln ( \frac{{M}_{i}^{′}}{{P}_{i} ( m , α )} )$$

where P(m, α) is the distribution of template m for the orientation α. Here P(m, α) typically represents a harmonized model, description, or approximation of M′. The distribution P(m, α) can be uniform in each sectors/portions of HVS values or can be a bump function. The invention is not limited by the way the distribution is defined. According to a variant, the template Tₘ₁ and the associated orientation α1 are selected such that it matches the hue distribution M, i.e. such that the Kullback-Leibler divergence

$$d 1 = {\sum }_{i} {M}_{i}^{′} * ln ( \frac{{M}_{i}^{′}}{{P}_{i} ( m 1 , α 1 )} )$$

is below a threshold value. In this case, the template is not necessarily the one that best fits the hue distribution M′, but it is close to the hue distribution M′.

Both templates Tₘ₀ and Tₘ₁ are then combined and the most similar template to this combination, among the nine harmonious templates, is selected by minimizing the Kullback-Leibler divergence between the combination and the distribution computed for each template and each orientation. According to a variant, a template is selected such that the Kullback-Leibler divergence between the combination of templates and the distribution computed for the selected template is below a threshold value. First, both templates are combined to form a new distribution P′. The combination comprises taking for each bin the maximum value in the histogram of the template computed on the whole image and in the template computed on the salient pixels. For each bin i, P′ᵢ=max(Pᵢ(m₀,α₀),Pᵢ(m₁,α₁)).

Second, the template Tₘ₃ and orientation α3 most similar to the combination, among the nine harmonious templates, is found by minimizing the Kullback-Leibler divergence between the combination and the distribution computed for each template and each orientation, i.e. the template and orientation that minimizes:

$${min}_{m , α} {\sum }_{i} {P}_{i}^{′} * ln ( \frac{{P}_{i}^{′}}{{P}_{i} ( m , α )} )$$

According to a variant, the most similar template Tₘ₃ with orientation α3 is compared to the whole image histogram. To this aim, the following Kullback-Leibler divergence is computed:

$$d 3 = {\sum }_{i} {M}_{i}^{′} * ln ( \frac{{M}_{i}^{′}}{{P}_{i} ( m 3 , α 3 )} )$$

If this divergence d3 is higher than k times the Kullback-Leibler divergence d1 between the whole image histogram and the template Tₘ₁ with the associated orientation α1, where k is for example equals to 2, then the next most similar template Tₘ₄ with the orientation α4 to the combination, among the eight remaining harmonious templates (the template Tₘ₃ and orientation α3 being removed from the set), is selected by minimizing the Kullback-Leibler divergence between the combination and the distribution computed for each template and each orientation, i.e. the template and orientation that minimizes:

$${min}_{m , α} {\sum }_{i} {P}_{i}^{′} * ln ( \frac{{P}_{i}^{′}}{{P}_{i} ( m , α )} )$$

The process is iterated until the template and orientation most similar to the combination and whose Kullback-Leibler divergence with the whole image histogram is lower than k times the Kullback-Leibler divergence between the original image histogram and the template Tₘ₁ with the associated orientation α1 is found.

According to a variant, a template Tₘ₃ and an orientation α3 are selected such that the Kullback-Leibler divergence between the combination of templates and the distribution computed for the selected template is below a threshold value. In this case, the template (Tₘ₃, α3) is not necessarily the one that best fits the hue distribution M′, but it is close to the hue distribution M′.

At a step 16, the pixels of the original image are mapped into the determined template. The template is either determined based only on the salient areas or is the combined template. More precisely, the outliers (in the sense that they are outside the selected template) are mapped into the harmonious sector(s) or close to by applying sophisticated tone mapping functions.

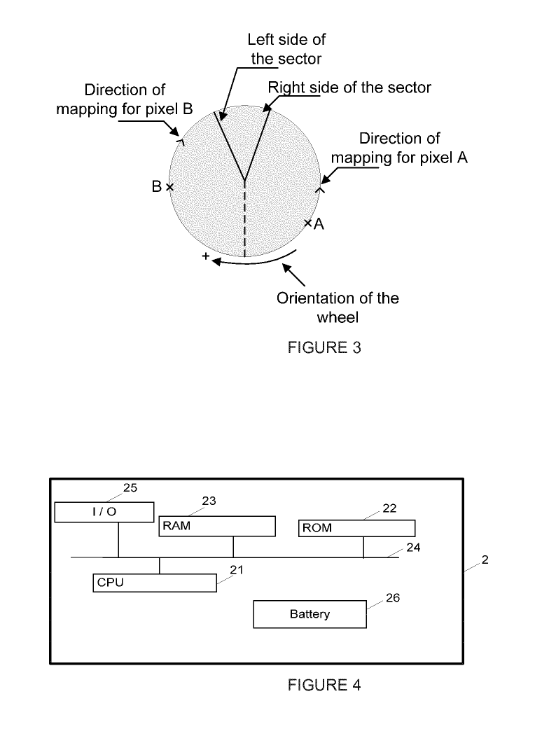

A sigmoid function is thus used to map the hue of each pixel p:

$${H}^{′} ( p ) = C ( p ) + Sgn * \frac{w}{2} * tanh ( \frac{2 * ‖ H ( p ) - C ( p ) ‖}{w} )$$

where C(p) is the central hue of the sector associated with p, w is the arc-width of the template sector and ∥ ∥ refers to the arc-length distance on the hue wheel and Sgn is the sign associated with the direction of mapping. A pixel is for example mapped on a sector side that is the closest. As depicted on FIG. 3, the pixel A is for example mapped on the right side of the sector since it is the closest side while pixel B is mapped on the left side of the sector. The hue wheel being oriented, Sgn is positive when the direction of mapping and the orientation of the wheel are in opposite direction (case of pixel A) while the Sgn is negative (case of pixel B) otherwise. According to the invention, the direction of mapping for a given pixel is not necessarily determined so that the pixel is mapped in the closest side of the sector. This sigmoid has good attributes for pixel mapping. Its asymptote in extreme value auto-clamp pixels in the template and its middle section (normal behavior) is nearly linear so, at the center of a sector, hues are not changed. The proposed mapping function guarantees original hue values at the center of the harmonious sectors and compresses more strongly hue values outside the template. The harmonic colors are preserved, and only non-harmonic hues are modified.

However skin and sky areas are not natural when modified in the pixel mapping step 16 as disclosed above. Indeed, some artifacts may be created during this step because two neighboring pixels that have similar colors can be mapped in opposite directions and consequently in opposite sides of a same sector or in different sectors. According to another embodiment, to remove these artifacts, a color quantized map CM or segmentation map of the original image is determined in an optional step 14 and is used during the step 16 to ensure that all pixels in the same segmented area of the CM map or segmentation map are mapped in the same direction of mapping and consequently in the same sector. This direction of mapping is for example the one mostly assigned to the pixels in a given segmented area. This direction of mapping is stored for example in a direction mapping map that associates with each pixel the direction of mapping of its segmented area. The color quantized map CM or segmentation map defines different regions in the original image that have close colors. Any method providing such a map can be used. As an example, the method described in “Learning Color Names for Real-World Applications” by J. van de Weijer et al published in IEEE Transactions in Image Processing 2009 is a solution. For color harmonization, the spatial aspect of the color segmentation is not compulsory. Therefore, a histogram segmentation technique is adequate here, such as the popular K-means method. However, such histogram segmentation should respect the following constraints:
It should be unsupervised, meaning that the final number of color clusters should not be a parameter. As a matter of fact, the color harmonization would be very sensitive to an incorrect number of meaningful colors.
The histogram segmentation technique should be capable of segmenting small modes of the histogram. In other words, small regions that could be seen as color outliers should be detected as separate modes.

In order to meet these requirements, a color segmentation method is disclosed that build on the work of Delon et al. referred to as ACoPa (Automatic Color Palette) and disclosed in the paper entitled “A nonparametric approach for histogram segmentation” published in IEEE Transactions on Image Processing, 16(1):253-261, 2007. This color segmentation technique is based on a contrario analysis of the color histogram modes. A statistical estimation of meaningful histogram modes is performed. Instead of the hierarchical estimation of modes in the H, then S, then V space, a histogram decomposition of each component is performed independently. The obtained modes are combined from all modes obtained, and segments with a very limited group of pixels are discarded. Finally, based on these histograms modes, a K-means post-processing is used to group the modes that are perceptually similar using a dictionary expressed in the Lab color space.

This segmentation technique is approximately 10 times faster than the original version. Besides, it deals more efficiently with achromatic pixels. Using a non-spatial algorithm allows to treat all pixels having the same colors without a priori on their position.

The segmentation is not perfect and some artifacts may appear at borders of segmented areas if each area has a different direction of mapping while their colors are originally close. These artifacts appear only on frontiers of segmented areas that undergo a hue mapping in opposite directions.

According to another embodiment, a post processing step is thus applied which blurs pixels at borders thanks to an average filter in order to overcome the above problem. Concerned frontiers are detected thanks to a gradient filter applied on the direction mapping map to get a mask identifying pixels to be blurred. The mask is used to blur the corresponding pixels in the modified hue picture obtained at step 16. The number of pixels to be blurred depends on the amount of blur at this location in the source picture. Indeed originally sharp areas have not to be blurred, which could be disturbing. The amount of blur is for example computed based on the method disclosed in document from H. Tong, M. Li et al entitled “Blur detection for digital images using wavelet transform,” IEEE International Conference on Multimedia & Expo, IEEE Press, pp. 17-20, 2004.

FIG. 4 represents an exemplary architecture of a processing device 2 according to a specific and non limiting embodiment. The processing device can be for example a tablet, a PDA or a cell phone. Processing device 2 comprises following elements that are linked together by a data and address bus 24
a microprocessor 21 (or CPU), which is, for example, a DSP (or Digital Signal Processor);
a ROM (or Read Only Memory) 22;
a RAM (or Random Access Memory) 23;
one or several Input/Output interface(s) 25, for example a keyboard, a mouse; and
a battery 26.

Each of these elements of FIG. 3 are well known by those skilled in the art and won't be disclosed further. The processing device 2 may comprise display means such as a screen for displaying the processed images. In each of mentioned memory, the word <<register>> used in the specification can correspond to area of small capacity (some bits) or to very large area (e.g. a whole program or large amount of received or decoded data). According to a particular embodiment, algorithms of the processing method according to the invention are stored in the ROM 22. RAM 23 comprises in a register, the program executed by the CPU 21 and uploaded after switch on of the processing device 2. When switched on, the CPU 21 uploads the program in the RAM and executes the corresponding instructions. The images to be processed are received on one of the Input/Output interfaces 25. One of the Input/Output interface 25 is adapted to transmit the images processed according to the invention.

According to variants, processing devices 2 compatible with the invention are implemented according to a purely hardware realisation, for example in the form of a dedicated component (for example in an ASIC (Application Specific Integrated Circuit) or FPGA (Field-Programmable Gate Array) or VLSI (Very Large Scale Integration) or of several electronic components integrated into a device or even in a form of a mix of hardware elements and software elements.

1-10. (canceled)

11. A method comprising:
selecting a first template of harmonious colors matching a color histogram of regions of interest in an image; and
mapping the colors of the image into a final template determined based on the first template, wherein the first template and the final template define portion(s) of harmonious color values.

12. The method according to claim 11, further comprising:
selecting a second template of harmonious colors matching a color histogram of said image;
combining said first and second templates into a combined template; and
selecting a template of color harmony matching said combined template, said final template being said combined template.

13. The method according to claim 11, further comprising segmenting the image into regions of similar colors, wherein the final template of harmonious colors comprising different portions of harmonious colors, mapping the colors of the image comprises mapping all the pixels of a segmented region into one and the same portion of the final template.

14. The method according to claim 11, wherein the regions of interests are determined by binarising a saliency map.

15. The method according to claim 11, wherein mapping the colors of the image into the final template is done according to a sigmoid function.

16. The method according to claim 11, further comprising blurring the pixels located on frontiers in the picture.

17. A device comprising at least a processor configured to :
select a first template of harmonious colors matching a color histogram of regions of interest in an image; and
map the colors of the image into a final template determined based on the first template, wherein the first template and the final template define portion(s) of harmonious color values.

18. The device according to claim 17, wherein the at least one processor is further configured to:
select a second template of harmonious colors matching a color histogram of said image;
combine said first and second templates into a combined template; and
select a template of color harmony matching said combined template, said final template being said combined template.

19. The device according to claim 18, wherein the at least one processor is further configured to segment the image into regions of similar colors, wherein the final template of harmonious colors comprising different portions of harmonious colors, mapping the colors of the image comprises mapping all the pixels of a segmented region into one and the same portion of the final template.

20. The device according to claim 17, wherein the regions of interests are determined by binarising a saliency map.

21. The device according to claim 17, wherein mapping the colors of the image into the final template is done according to a sigmoid function.

22. The device according to claim 17, further comprising blurring the pixels located on frontiers in the picture.
